(19) United States
(12) Patent Application Publication
(10) Pub. No.: US 2015/0310345 A1
(43) Pub. Date: Oct. 29, 2015

(54) MODELING INCREMENTALTREATMENT EFFECT AT INDIVIDUAL LEVELS USING A SHADOW DEPENDENT VARIABLE

(71) Applicant: BANK OF AMERICA CORPORATION, Charlotte, NC (US)

(72) Inventor: Xiaohu Liu, West Chester, PA (US)

(73) Assignee: BANK OF AMERICA CORPORATION, Charlotte, NC (US)

(21) Appl. No.: 14/263,543

(22) Filed: Apr. 28, 2014

(51) Int. Cl. G06N 7/00

(52) U.S. Cl. CPC G06N 7/00

(57) ABSTRACT

Embodiments of the invention are directed to systems, methods and computer program products for utilizing a shadow ridge rescaling technique to model incremental treatment effect at the individual level, based on a randomized test and control data. A shadow dependent variable is introduced with its mathematical expectation being exactly the incremental effect. Ridge regression is utilized to regress the shadow dependent variable on a set of variables generated from the test model score and the control model score. A tuning parameter in the ridge regression is selected so that the score can best rank order the incremental effect of the treatment. The final score is a nonlinear function of the test model score plus a nonlinear function of a control model score, and outperforms the traditional differencing score method.

### FIELD

This application relates to the field of computer modeling, and specifically creating a computer modeling technique to determine values for the incremental benefit on an individual when performing a treatment (otherwise described as an action) as opposed to not performing the treatment.

### BACKGROUND

Modeling techniques have been used in the past to try to determine the incremental effect (e.g., a value of the benefit) of performing a treatment with respect to an individual as opposed to not performing a treatment or performing a different treatment with respect to the same individual. When test and control data is available, a widely used method to determine an incremental effect is based on regression techniques that model the incremental effect using a differencing score method (hereinafter “DSM”). With respect to the DSM, assume Y is an individual's performance metric in which there is an interest. The DSM develops a test model to estimate the individual's performance under treatment, E(Y|treated), and develops a control model to estimate the individual's performance under no treatment, E(Y|not treated), and then takes the difference between the test model score and the control model score as the final score. As such, at the individual level, the final score is the estimate of the incremental effect E(Y|treated)−E(Y|not treated). The problem with the DSM is that it rarely works well for real world problems. One of the major drawbacks of DSM is that the test model and the control model are developed separately, and nothing in the regression fitting process explicitly attempts to fit the difference in the performance between the test group and the control group.

In some cases, the performance metric Y is a binary variable with a value of 1 or 0, wherein 1 stands for an event that an institution desires to happen, and 0 stands for non-event. The event that a finance institution desires may be an individual making a purchase of a certain product, making a payment on a billed statement, starting to actively use a credit card, becoming profitable, or any other like event. In such cases, the incremental effect E(Y|treated)−E(Y|not treated) is reduced to P(Y=1|treated)−P(Y=0|not treated). When the dependent variable Y is binary, another method called the probability decomposition method (hereinafter “PDM”), may be utilized, which is based on the test group data and the data associated with event records. This method can only be applied to the case when the size of test group and the size of control group are equal. Generalizations have been made to PDM to allow for unequal sized test group and control group. An alternative PDM is proposed, which is based on the control group data and the data associated with non-event records. However, the limitation of these PDMs is that they cannot be applied to the case when Y is continuous.

A one-model approach has also been used to predict incremental effect. The one-model approach is to regress the dependent variable Y on a binary treatment flag, a set of predictors, and interaction terms formed by the product of the treatment flag and each of the predictors. As a result, the one-model approach is able to estimate the performance under treatment by setting the treatment flag=1, and estimate the performance under no treatment by setting the treatment flag=0. The final score is taken as the difference of the two estimated performances. The key to make this method successful relies on how to specify the interaction terms. Although this method is likely better than DSM, the relationship between the incremental effect and an individual predictor is often non-linear, and thus, this method does not tell how to specifically model a nonlinear pattern between the incremental effect and the individual predictor through the specification of the interaction terms.

The present invention overcomes these issues with the models that are currently used to determine an incremental effect at individual levels.

### BRIEF SUMMARY

Embodiments of the invention comprise a system, computer program product, and methods for a shadow ridge rescaling (hereinafter “SRR”) technique that combines a test model score and a control model score to provide a more effective technique to determine the incremental effect of a treatment. The treatment may include providing an offer or incentive to a customer to get the customer to take an action, such as but not limited to providing a financing option (e.g., 0% interest, cash back bonus, or the like) to get the customer to sign up for a credit card, or the like. Other treatments may include providing a notification to the customer that a payment deadline is approaching. Still other treatments may be providing a reduced interest rate for refinancing a mortgage. While the treatments described herein are described with respect to a financial institution, it should be understood that the modeling methods discussed herein may be applied to any type of situation in which one is trying to identify the incremental effect of taking an action versus not taking an action or taking an alternate action.

In the SRR technique discussed herein, the concept of a shadow dependent variable is introduced, whose mathematical expectation is exactly the incremental effect for each individual. Ridge regression is utilized to regress the shadow dependent variable on a set of variables generated from the test model score and the control model score. A tuning parameter in the ridge regression is selected so that the score using the SRR technique can best rank order the incremental effect. The final score will be a nonlinear function of the test model score plus a nonlinear function of a control model score.

The example illustrated within this specification shows that the score determined by the SRR technique better rank orders the incremental effect than the other models that are currently used to determine incremental effect of a treatment. Using the SRR technique to determine the incremental effect at the individual level is important for developing cost effective business strategies that benefit both the customer and the business.

Embodiments of the invention comprise systems, computer program products, and methods for modeling incremental effect, the system comprising. The invention comprises splitting data for observations into development data and validation data; creating a test group model from the development data based on test group observations that are subject to a treatment; creating a control group model from the development data based on control group observations that are not subject to the treatment; creating a shadow dependent variable for the development data, wherein the shadow dependent variable is dependent on the test group observations, the control group observations, and a measurement performance variable; scoring the development data by applying the test group model and the control group model to the development data; creating cubic spline basis functions for the test group model and the control group model; standardizing the shadow dependent variable and the cubic spline basis functions using the development data; creating a design matrix of the standardized shadow dependent variable and the cubic spline basis functions; conducting a singular value decomposition on the design matrix; utilizing a binary search algorithm to determine tuning parameters for a set of degree of freedoms from the singular value decomposition; calculating a parameter vector for each of the tuning parameters; creating a scoring formula based on the standardized cubic spline basis functions and the parameter vector for each of the tuning parameters; calculating scores for each of the tuning parameters using the scoring formula and the validation data; calculating an incremental effect area index of the scores for the tuning parameters values using the validation data; identifying a tuning parameter from the tuning parameters corresponding to a score from the scores that has a highest incremental effect area index; and wherein the tuning parameter with the score having the highest incremental effect area index is used to rank order an incremental effect of the treatment.

In further accord with embodiments of the invention, observations are further split into holding data that is used to determine the accuracy of the incremental effect model score.

In another embodiment of the invention, the shadow dependent variable is defined by the following equation:

$$Z = \{ \begin{matrix}\frac{n}{{n}_{t}} Y & if the individual is in test \\ - \frac{n}{{n}_{c}} Y & if the individual is in control\end{matrix} ;$$

and
wherein nₜ is a number of test group observation, n_{c} is a number of control group observations, n is a total number of observations, and Y is the measurement performance variable.

In yet another embodiment of the invention, the cubic spline basis functions of the test group are

$${U}_{1} = {P}_{1} , \\ {U}_{2} = {P}_{1}^{2} , \\ {U}_{3} = {P}_{1}^{3} , \\ {U}_{4} = {( {P}_{1} - {a}_{1} )}^{3} \cdot 1 ( {P}_{1} \leq {a}_{1} ) , \\ {U}_{5} = {( {P}_{1} - {a}_{2} )}^{3} \cdot 1 ( {P}_{1} \leq {a}_{2} ) , \\ …$$

$${U}_{k + 3} = {( {P}_{1} - {a}_{k} )}^{3} \cdot 1 ( {P}_{1} \leq {a}_{k} ) ;$$

the cubic spline basis functions of the control group are

$${V}_{1} = {P}_{2} , \\ {V}_{2} = {P}_{2}^{2} , \\ {V}_{3} = {P}_{2}^{3} , \\ {V}_{4} = {( {P}_{2} - {b}_{1} )}^{3} \cdot 1 ( {P}_{2} \leq {b}_{1} ) , \\ {V}_{5} = {( {P}_{2} - {b}_{2} )}^{3} \cdot 1 ( {P}_{2} \leq {b}_{2} ) , \\ …$$

$${V}_{k + 3} = {( {P}_{2} - {b}_{k} )}^{3} \cdot 1 ( {P}_{2} \leq {b}_{k} ) .$$

In still another embodiment of the invention, standardizing the shadow dependent variable and the cubic spline basis functions using the development data comprises subtracting the variable's mean and dividing the difference by the variable's standard deviation, wherein the mean the standard deviation are calculated from the development data.

In further accord with an embodiment of the invention, conducting the value decomposition for the design matrix (X) comprises using a formula

X=Q₁DQ₂^{T}; and

wherein Q₁ and Q₂ are n×(2k+6) and (2k+6)×(2k+6) orthogonal matrices, D is a (2k+6)×(2k+6) diagonal matrix, with diagonal entries d₁″d₂≧ . . . ≧d₂ₖ₊₆≧0 called the singular values of matrix X.

In another embodiment of the invention, utilizing the binary search algorithm to determine the tuning parameters for the set of degree of freedoms from the singular value decomposition comprises:
set δ as an estimation error allowed;
identify the tuning parameters for each dfⱼ;
initialize end points of the searching interval by letting x₁=0 and x₂=u;
calculate

$$x = \frac{{x}_{1} + {x}_{2}}{2} and df = {\sum }_{i = 1}^{2 k + 6} \frac{{d}_{i}^{2}}{{d}_{i}^{2} + x} ;$$

when |df−dfⱼ|≦δ then×is the value of the turning parameter corresponding to dfⱼ;
when |df−dfⱼ|>δ then update the end points such that if df<dfⱼ then let x₂=x, otherwise let x₁=x, recalculate

$$x = \frac{{x}_{1} + {x}_{2}}{2} and df = {\sum }_{i = 1}^{2 k + 6} \frac{{d}_{i}^{2}}{{d}_{i}^{2} + x} ,$$

and iterate until |df−Dfⱼ|≦δ is met.

In yet another embodiment of the invention, the parameter vector is calculated for each of the tuning parameters λⱼ using the following formula:

$${\hat{β}}_{ridge} ( {λ}_{j} ) = {Q}_{2} Diag ( \frac{{d}_{1}}{{d}_{1}^{2} + {λ}_{j}} , \frac{{d}_{2}}{{d}_{2}^{2} + {λ}_{j}} , … , \frac{{d}_{2 k + 6}}{{d}_{2 k + 6}^{2} + {λ}_{j}} ) {Q}_{1}^{T} {z}^{*} .$$

In still another embodiment of the invention, the scoring formula is

S(λⱼ)=(U₁*, U₂*, . . . , Uₖ₊₃*, V₁*, V₂*, . . . , Vₖ₊₃*)\hat{β}_{ridge}(λⱼ).

In yet another embodiment of the invention, calculating the incremental effect area index of the scores for the tuning parameters values using the validation data comprises ranking the observations in the validation data based on the scores from low to high; determining an average response (Y) value for the test group and the an average response variable (Y) value for the control group for increasing percentages of observations of the scores from lowest to highest; determining a cumulative incremental effect value that is equal to the difference between the average response (Y) value for the test group and the average response (Y) value for the control group for the increasing percentages of observations of the scores from lowest to highest; assuming the cumulative incremental effect value is C(p) when the percentage of observations is p; and calculating the incremental effect area index using formula:

$$1 - \frac{1}{C ( 1 )} \{ \frac{{p}_{1} + {p}_{2}}{2} C ( {p}_{1} ) + {\sum }_{i = 2}^{s} \frac{{p}_{i + 1} - {p}_{i - 1}}{2} C ( {p}_{i} ) + \frac{{p}_{s} - {p}_{s - 1}}{2} C ( {p}_{s} ) \} .$$

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, where:

FIG. 1A is a process flow for a SRR technique for modeling incremental effect, in accordance with embodiments of the present invention;

FIG. 1B is a continuation of the process flow for the SRR technique for modeling incremental effect shown in FIG. 1A, in accordance with embodiments of the present invention;

FIG. 2 is process flow for searching for a tuning parameter within an interval for a given degrees of freedom, in accordance with embodiments of the present invention;

FIG. 3 is process flow for calculating the incremental effect area index for a given score, in accordance with embodiments of the present invention; and

FIG. 4 is a system diagram for executing the present invention, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In test and control data, an individual is either treated or not treated. When an individual is in the test group, you can only observe the individual's performance under treatment. When an individual is in the control group, you can only observe the individual's performance under no treatment. Hence at an individual level, you cannot observe both the performance under treatment and the performance under no treatment simultaneously. That is, at individual level, you cannot observe the incremental effect. This causes a challenge when trying to model the incremental effect of a treatment using a test group and a control group.

The present invention is a new technique called Shadow Ridge Rescaling (hereinafter “SRR”) that used to combine the test model score and the control model score more effectively. In the SRR technique (also described herein as the SRR process) of the present invention we introduce a shadow dependent variable. Mathematically, at an individual level the expectation of the shadow dependent variable is exactly the incremental effect. However, in practice the shadow dependent variable is not exactly the incremental effect, but it may be used as a reference or an intermediate dependent variable in the model fitting process of the present invention. The present invention regresses the shadow dependent variable on the variables created from the test model score and the control model score. As such, the final score will be a nonlinear function of the test model score plus a nonlinear function of a control model score.

As will be discussed herein, the data used in the SRR technique of the present invention should be large enough to randomly split it into two parts, a development data part and a validation data part. The development data is used to develop a set of candidate model scores for rank ordering incremental effect. The validation data is used to select the final model score. In the present invention, the randomized test and control data are randomly assigned for treatment and no treatment. By definition, incremental effect is defined as E (Y|treated)−E(Y|not treated). Assume a test model score P₁ is already developed to estimate E(Y|treated) using the observations in test group of the development data, and a control model score P₂ is already developed to estimate E(Y|not treated) using the observations in control group of the development data. Both models may be applied to score all individuals in both the test and control groups using the development data. The traditional method DSM is to simply calculate P₁−P₂ as the final score for estimating the incremental effect. Usually this difference based method does not work well, especially when the score is applied on hold out validation data, which is explained in further detail later.

In order to determine the quality of a given score, regardless of how the score is determined, the incremental effect area index may be utilized. The incremental effect area index may be used to measure the quality of a given score in rank ordering incremental effect. We discuss incremental effect area index below; however, it is described in depth in U.S. Patent Application No. 2013/0238539, filed by Liu et al. on Mar. 9, 2012, and published on Sep. 12, 2013, which is assigned to the assignee of the present invention, and further is incorporated by reference in its entirety herein.

With respect to the incremental effect area index, we first assume a score has been created for a given data for estimating the incremental effect. We rank order the observations by their score values from low to high and let 0<p≦1. For a given 100×p% of observations with lowest score values, we calculate the average Y in the test group and the average Y in control group, then take the difference of the two averages. We call this difference C(p). When p varies, C(p) is a function of p, called the cumulative incremental effect function.

Mathematically, the formula for the incremental effect area index is:

$$Incremental effect area index = 1 - \frac{1}{C ( 1 )} {\int }_{0}^{1} C ( p ) d p$$

In the figure below, we may assume the cumulative incremental effect function C(p) is plotted as the curve (CB).

Geometrically, the formula for the incremental effect area index is:

$$Incremental effect area index = \frac{area of region ( ABC )}{area of rectangle ( ABEO )} .$$

In practice, we calculate an approximate value of the area index using Simpson's trapezoidal rule. We select s points p₁, p₂, . . . , pₛ in [0,1]. Usually we select

$${p}_{i} = \frac{i}{s} ( i = 1 , 2 , … , s )$$

and select s=10 or 20. For each of these pᵢ's, we calculate C(pᵢ) . Then the incremental effect area index is approximately equal to:

$$1 - \frac{1}{C ( 1 )} \{ \frac{{p}_{1} + {p}_{2}}{2} C ( {p}_{1} ) + {\sum }_{i = 2}^{s} \frac{{p}_{i + 1} - {p}_{i - 1}}{2} C ( {p}_{i} ) + \frac{{p}_{s} - {p}_{s - 1}}{2} C ( {p}_{s} ) \} .$$

In the present invention we propose utilizing a method called “shadow ridge rescaling” (SRR) which finds a nonlinear function of P₁, f₁(P₁), and a nonlinear function of P₂, f2(P2), so that f₁(P₁)+f₂(P₂) can better estimate the incremental effect than is currently estimated using P₁−P₂(i.e., the difference of the 2 models).

In the SRR model we let nₜ be the number of individuals in the test group of the development data, and n_{c} be the number of individuals in the control group of the development data. The total number of observations in the development data is n=nₜ+n_{c}.

With respect to the SRR technique, utilizing development data we first combine the test data and the control data to form one single data set, and introduce the following variable:

$$Z = \{ \begin{matrix}\frac{n}{{n}_{t}} Y & if the individual is in test \\ - \frac{n}{{n}_{c}} Y & if the individual is in control\end{matrix} \qquad ( 1 )$$

Since any individual in the data is randomly assigned to test group and control group, the probability that this given individual is assigned to test group is

$$p ( test ) = \frac{{n}_{t}}{n} ,$$

and the probability that this given individual is assigned to control group is

$$p ( control ) = \frac{{n}_{c}}{n} .$$

Mathematically, for any given individual,

$$\begin{matrix}E ( Z ) = P ( test ) E ( Z \vert test ) + P ( control ) E ( Z \vert control ) \\ ( by total expectation formula ) \\ = \frac{{n}_{t}}{n} E ( \frac{n}{{n}_{t}} Y \vert test ) + \frac{{n}_{c}}{n} E ( - \frac{n}{{n}_{c}} Y \vert control ) \\ = E ( Y \vert test ) - E ( Y \vert control ) \\ = E ( Y \vert treated ) - E ( Y \vert not treated ) .\end{matrix}$$

In the above equations, E(·) is the operation of taking the mathematical expectation. For example, E(Y|test) is the conditional expectation of Y given the individual is in test group. While Z itself is not equal to the incremental effect, its mathematical expectation is equal to the incremental effect. Hence Z is closely associated with the target we are trying to determine the incremental effect. We call Z the shadow dependent variable.

In the SRR technique, we estimate the shadow dependent variable Z using the test model score P₁ and the control model score P₂. In order to model the potential nonlinear relationship between Z and each of P₁ and P₂, we use the cubic spline basis functions of P₁, and of P₂ to estimate Z. To construct the cubic spine basis functions for P₁, we generate k knots a₁, a₂, . . . , aₖ to divide the range of P₁ into k+1 intervals so that each interval has roughly the same number of observations, if possible. Similarly, we generate k knots b₁, b₂, . . . , bₖ to divide the range of P₂ into k+1 intervals. In practice, we often choose k=4, 9, 14, or 19. In other embodiments other numbers may be used for k.

The k+3 cubic spline basis functions of P₁ are defined as:

$${U}_{1} = {P}_{1} , \\ {U}_{2} = {P}_{1}^{2} , \\ {U}_{3} = {P}_{1}^{3} , \\ {U}_{4} = {( {P}_{1} - {a}_{1} )}^{3} \cdot 1 ( {P}_{1} \leq {a}_{1} ) , \\ {U}_{5} = {( {P}_{1} - {a}_{2} )}^{3} \cdot 1 ( {P}_{1} \leq {a}_{2} ) , \\ …$$

$${U}_{k + 3} = {( {P}_{1} - {a}_{k} )}^{3} \cdot 1 ( {P}_{1} \leq {a}_{k} ) .$$

And the k+3 cubic spline basis functions of P₂ are defined as:

$${V}_{1} = {P}_{2} , \\ {V}_{2} = {P}_{2}^{2} , \\ {V}_{3} = {P}_{2}^{3} , \\ {V}_{4} = {( {P}_{2} - {b}_{1} )}^{3} \cdot 1 ( {P}_{2} \leq {b}_{1} ) , \\ {V}_{5} = {( {P}_{2} - {b}_{2} )}^{3} \cdot 1 ( {P}_{2} \leq {b}_{2} ) , \\ …$$

$${U}_{k + 3} = {( {P}_{2} - {b}_{k} )}^{3} \cdot 1 ( {P}_{2} \leq {b}_{k} ) .$$

We then standardize Z, and the variables Uⱼ(j=1, 2, . . . , k+3) and V_{.j}(j=1, 2, . . . , k+3). By standardizing a variable, we mean that we subtract the variable by its sample mean and then divide the resulting difference by the variable's sample standard deviation. Let the standardized versions of Z, (j=1, 2, . . . , k+3), and Vⱼ(j=1, 2, . . . , k+3), be Z*, (j=1, 2, . . . , k+3), and Vⱼ*(j=1, 2, . . . , k+3), respectively.

Next, we model Z* on Uⱼ*(j=1, 2, . . . , k+3) and Vⱼ*(j=1, 2, . . . , k+3) as a linear model:

Z*=α₁U₁*+α₂U₂*+ . . . +αₖ₊₃Uₖ₊₃*+γ₁V₁*+γ₂V₂*+ . . . +γₖ₊₃Vₖ₊₃*+ε (2)

where ε is the random error term.

Then we let z*, u₁*, u₂*, . . . , uₖ₊₃*, v₁*, v₂*, . . . vₖ₊₃* be the column vectors in the data, corresponding to the variables Z*, U1, U₂*, . . . , Uₖ₊₃*, V₁*, V₂*, . . . , Vₖ₊₃* respectively. We let X=(u*₁, u2*, . . . , uₖ₊₃*, v₁*, v₂*, . . . ,vₖ₊₃*) be the n×(2k+6) design matrix. We let β=(α₁, α₂, . . . , αₖ₊₃, γ₂, , γₖ₊₃*)^{T} be the parameter vector with 2k+6 entries, and ε be the column vector of random error, with n entries.

Then, equation (2) can be written as:

z*=Xβ+ε (3)

We introduce the ridge regression to estimate β by solving the optimization problem:

min(z*−Xβ)^{T}(z*−α)+λβ^{T}β (4)

Here λ≧0 is the tuning parameter.

The solution to the optimization problem is:

\hat{β}_{ridge}(λ)=(X^{T}X+λI)⁻¹X^{T}z* (5)

For any given λ, we can use equation (5) to calculate the parameter vector \hat{β}_{ridge}(λ). Notice that \hat{β}_{ridge}(λ)=(\hat{α}₁(λ), \hat{α}₂(λ), . . . , \hat{α}ₖ₊₃(λ), \hat{γ}₁(λ), \hat{γ}₂(λ), . . . , \hat{γ}ₖ₊₃(λ))^{T}. Once the vector \hat{β}_{ridge}(λ) is calculated, the estimates of the parameters are all known. Hence we can create a score as:

S(λ)=\hat{α}₁(λ)U₁*+ . . . +\hat{α}ₖ₊₃(λ)Uₖ₊₃*+\hat{γ}₁(λ)V₁*+ . . . +\hat{γ}ₖ₊₃(λ)Vₖ₊₃* (6)

We note that when λ=0, \hat{β}_{ridge}(λ) is equal to the ordinary least square estimate, and when λ=+∞, \hat{β}_{ridge}(λ)=0. Since there are infinite number of choices of λ, there are infinite number of parameter vector estimates \hat{β}_{ridge}(λ).

We then need to select the tuning parameter λ so that \hat{β}_{ridge}(λ) will lead to the best score. For ridge regression, there are methods for selecting by only using the development data, for example, Akaike Information Criterion (AIC) and Schwarz Criteria (SBC). However, scores selected by these methods do not always perform very well in rank ordering the incremental effect of a treatment. A better option is to select λ based on the validation data so that the corresponding score has the best rank ordering property on the validation data.

In practice, based on the development data, we may test a set of λ values: λ₁, λ₂, . . . , λᵣ. For each λⱼ, we can create a corresponding score function S(λⱼ). Then we can apply the scoring formula of S(λⱼ) to the validation data, and calculate the incremental effect area index of the score using the validation data. We then select the final score as the score which has the highest incremental effect area index on the validation data.

Next, we describe an efficient numerical method to calculate the scores for a set of values of λ. For a given tuning parameter λ, the score S(λ) is determined by equation (6), and the parameter vector \hat{β}_{ridge}(λ)=(\hat{α}₁(λ), \hat{α}₂(λ), . . . , \hat{α}ₖ₊₃(λ), \hat{γ}₁(λ), \hat{γ}₂(λ), . . . , \hat{γ}ₖ₊₃(λ))^{T} is determined by equation (5).

In practice, we may want to test hundreds of λ values. To calculate α_{ridge}(λ), we would need to inverse the matrix X^{T}X+λI, and to test hundreds of λ values we would need to inverse hundreds of matrices. Instead of inversing hundreds of matrices, we may utilize singular value decomposition to simplify the calculation.

First, we conduct singular value decomposition (SVD) for the n×(2k+6) matrix X:

X=Q₁DQ₂^{T} (8)

In this equation Q₁ and Q₂ are n×(2k+6) and (2k+6)×(2k+6) orthogonal matrices, and D is a (2k+6)×(2k+6) diagonal matrix, with diagonal entries d₁≧d₂≧ . . . ≧d₂ₖ₊₆≧0 called the singular values of matrix X.

Based on equation (5), the ridge estimate of the parameter vector is:

\hat{β}_{ridge}(λ)=(X^{T}X+λI)⁻¹X^{T}z*=Q₂(D²+λI)⁻¹DQ₁^{T}z*.

As such,

$${\hat{β}}_{ridge} ( λ ) = {Q}_{2} Diag ( \frac{{d}_{1}}{{d}_{1}^{2} + λ} , \frac{{d}_{2}}{{d}_{2}^{2} + λ} , … , \frac{{d}_{2 k + 6}}{{d}_{2 k + 6}^{2} + λ} ) {Q}_{1}^{T} {z}^{*} \qquad ( 9 )$$

In this equation diag 0 converts a vector into a diagonal matrix. The score vector for the data is:

X\hat{β}_{ridge}(λ)=X(X^{T}X+λI)⁻¹X^{T}z*=Q₁D(D²+λI)⁻¹DQ₁^{T}z*

### Hence,

$$X {\hat{β}}_{ridge} ( λ ) = {Q}_{1} Diag ( \frac{{d}_{1}^{2}}{{d}_{1}^{2} + λ} , \frac{{d}_{2}^{2}}{{d}_{2}^{2} + λ} , … , \frac{{d}_{2 k + 6}^{2}}{{d}_{2 k + 6}^{2} + λ} ) {Q}_{1}^{T} {z}^{*} \qquad ( 10 )$$

The score vector contains the score values for all the records in the data.

Equation (9) provides a simple way to calculate the parameter vector using ridge regression. Equation (10) provides a simple way to calculate the score for all observations in the data. The benefit of using equations (9) and (10) is that no matrix inversion is needed at all.

For ridge regression, the degrees of freedom are used to measure the complexity of the model corresponding to the tuning parameter A, which is equivalent to the number of parameters specified in the model. The degrees of freedom corresponding to the tuning parameter λ are:

df(λ)=tr(X(X^{T}X+λI)⁻¹X^{T})=tr(Q₁D(D²+λI)⁻¹DQ₁^{T})=tr(D(D²+λI)⁻¹D)

Here tr(•) is the operation of taking the trace of a matrix, which is taking the sum of the diagonal elements of a matrix. The formula for calculating the degrees of freedom can be simplified further as follows:

$$d f ( λ ) = {\sum }_{i = 1}^{2 k + 6} \frac{{d}_{i}^{2}}{{d}_{i}^{2} + λ} \qquad ( 11 )$$

The d f (A) function is a monotonic decreasing function of λ. When λ=0, df(λ)=2k+6, and when=+∞, df(λ)=0. Based on equation (11), for any given degrees of freedom d f between 0 and 2k+6, we can find the corresponding λ using the binary search algorithm. In practice, we might want to find a set of values of λ, so that the corresponding degrees of freedom df takes some given values between 0 and (2k+6), for instance, 0.1, 0.2, . . . , (2k+6).

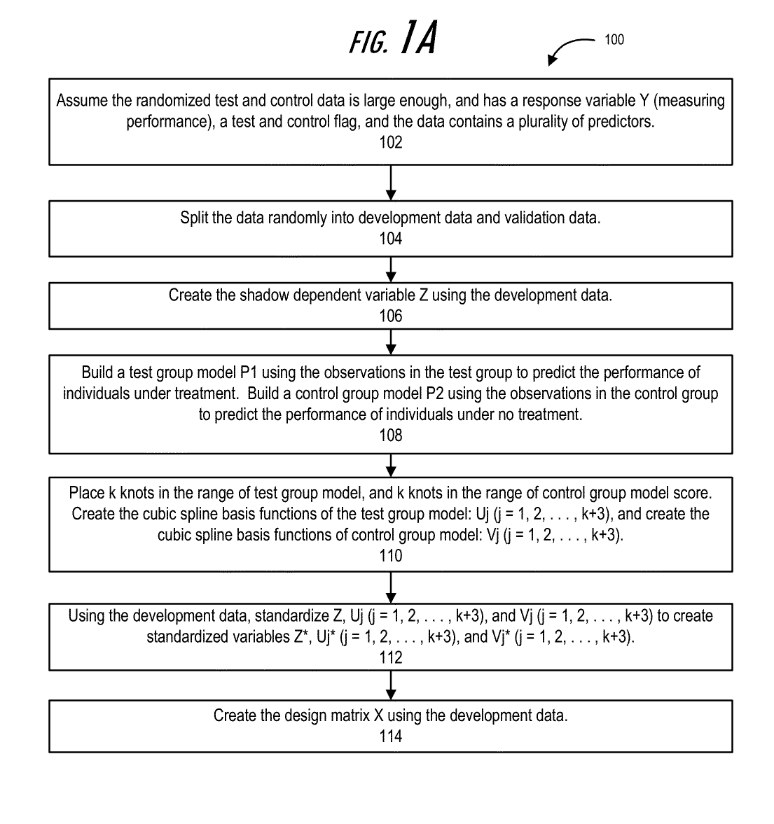

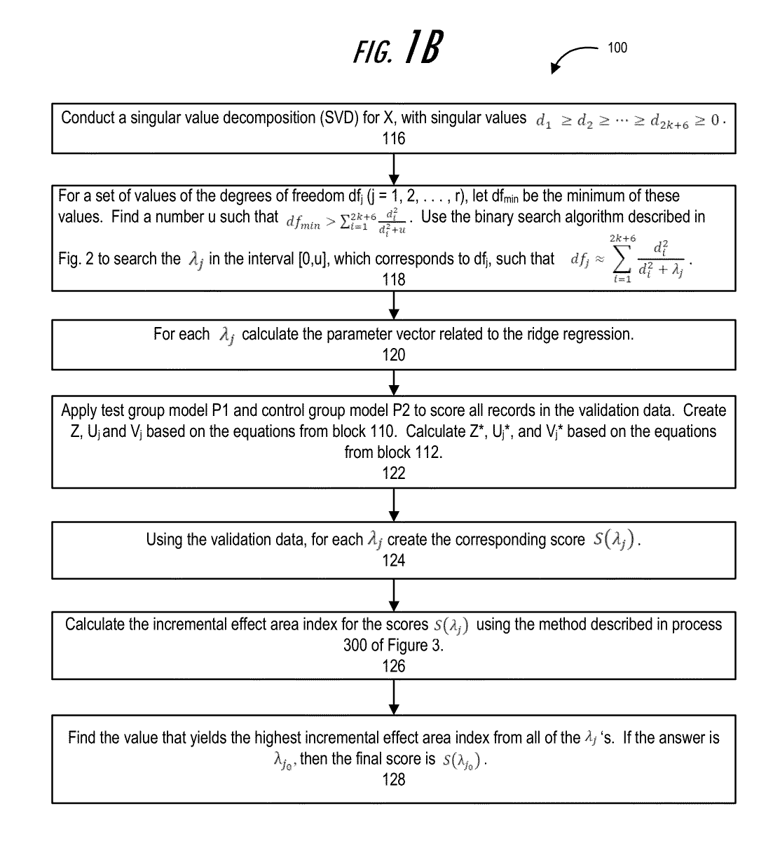

The present invention discussed generally above will now be discussed in further detail with respect to the FIGS. 1A-3 and the example provided herein. As illustrated by block 102 in FIG. 1, we first assume that the randomized test and control data being used is large enough to provide for an accurate score. In some embodiments the size of the data should be large enough to provide accurate results. As a rule of thumb, the bigger the data set, the better the score. Ideally, in the development data, both test group and control group should have at least 10,000 records each. Ideally, the validation data is as large and may include more then 10,000, 50,000, 100,000, or a million records. We also assume that the data has a response variable Y (measuring performance), a test and control flag, and that the data contains a plurality of predictors. Without these features the use of SRR to determine the incremental effect may not provide the desired results.

As illustrated by block 104, the data is split randomly into development data, and validation data. Typically, a 50% and 50% split may be utilized. In other embodiments of the invention, a 60% and 40% split is applied. In still other embodiments the split may be within, overlapping, or outside of these ranges, and further include a split into hold-out data used for validation of the scores.

Block 106 illustrates that the shadow dependent variable Z is created using the development data as:

$$Z = \{ \begin{matrix}\frac{n}{{n}_{t}} Y & if the individual is in test \\ - \frac{n}{{n}_{c}} Y & if the individual is in control\end{matrix}$$

Here nₜ is the number of individuals (observations) in the test group of the development data; n, is the number of individuals (observations) in the control group of the development data; and n is the total number of individuals (observations) in the development data.

As illustrated by block 108,a test group model P₁ is created using the observations in the test group of the development data in order to predict the performance of individuals under treatment. Additionally, a control group model P₂ is created using the observations in the control group of the development data in order to predict the performance of individuals under no treatment. After that, the test group model P₁ is applied to score records in the development data (including the records for both the test group and the control group). The control group model P₂ is also applied to score records in the development data (including the records for both the test group and the control group).

Block 110 illustrates that the development data is used to create the cubic spline basis functions of P₁ and P₂. The cubic spline basis functions are created by generating k knots a₁, a₂, . . . , aₖ to divide the range of P₁ into k+1 intervals so that each interval has the same or roughly the same number of observations. Similarly, the cubic spline basis functions are created by generating k knots b₁, b₂, . . . , bₖ to divide the range of P₂ into k+1 intervals so that each interval has the same or roughly the same number of observations, if possible.

The k+3 cubic spline basis functions of P₁ are defined as

$${U}_{1} = {P}_{1} , \\ {U}_{2} = {P}_{1}^{2} , \\ {U}_{3} = {P}_{1}^{3} , \\ {U}_{4} = {( {P}_{1} - {a}_{1} )}^{3} \cdot 1 ( {P}_{1} \leq {a}_{1} ) , \\ {U}_{5} = {( {P}_{1} - {a}_{2} )}^{3} \cdot 1 ( {P}_{1} \leq {a}_{2} ) , \\ … … … …$$

$${U}_{k + 3} = {( {P}_{1} - {a}_{k} )}^{3} \cdot 1 ( {P}_{1} \leq {a}_{k} ) .$$

And the k+3 cubic spline basis functions of P₂ are defined as

$${V}_{1} = {P}_{2} , \\ {V}_{2} = {P}_{2}^{2} , \\ {V}_{3} = {P}_{2}^{3} , \\ {V}_{4} = {( {P}_{2} - {b}_{1} )}^{3} \cdot 1 ( {P}_{2} \leq {b}_{1} ) , \\ {V}_{5} = {( {P}_{2} - {b}_{2} )}^{3} \cdot 1 ( {P}_{2} \leq {b}_{2} ) , \\ … … … …$$

$${V}_{k + 3} = {( {P}_{2} - {b}_{k} )}^{3} \cdot 1 ( {P}_{2} \leq {b}_{k} ) .$$

Notice that 1(·) is an indicator function. For instance, 1(P₁≦a₁) returns a value 1 if P₁<a₁, and returns 0 otherwise. In practice, k=4, 9, 14, or 19 is usually chosen. In practice, we may test each of these selections of k to see which k leads to the best result.

As illustrated by block 112, the development data is used to standardized Z, (j=1, 2, . . . , k+3), and Vⱼ(j=1, 2, . . . , k+3), to create standardized variables Z*, (j =1, 2, . . . , k+3), and Vⱼ*(j=1, 2, . . . , k+3). In one embodiment, standardizing the variables comprises subtracting the variable's mean and then dividing the difference by the variable's standard deviation, with the mean and the standard deviation calculated based on the development data.

As illustrated in block 114, the design matrix X is created using the development data. As such, z*, u₁, u₂*, . . . , uₖ₊₃*, v₁, v₂, . . . , vₖ₊₃* become the column vectors in the data, corresponding to the variables Z*, U₁, U₂*, . . . , Uₖ₊₃*, V₁, V₂*, . . . , Vₖ₊₃*, respectively. Then X=(u₁, u₂*, . . . , uₖ₊₃*, v₁, v₂, . . . , vₖ₊₃*).

Block 116 of FIG. 1B indicates that a singular value decomposition (SVD) is conducted for X as follows:

X=Q₁DQ₂^{T}

Here Q₁ and Q₂ are n×(2k+6) and (2k+6)×(2k+6) orthogonal matrices. D is a (2k+6)×(2k+6) diagonal matrix, with diagonal entries d₁≧d₂≧ . . . ≧d₂ₖ₊₆≧0 called the singular values of matrix X.

Block 118 illustrates that for a set of values of the degrees of freedom dfⱼ (j=1, 2, . . . , r), dfₘᵢₙ is the minimum value of these given degrees of freedom df₁ (j=1, 2, . . . , r). A number u is identified such that

$$d {f}_{min} > {Σ}_{i = 1}^{2 k + 6} \frac{{d}_{i}^{2}}{{d}_{i}^{2} + u} .$$

A possible way to find u is to test the following candidate values: 1, 10, 10², 10³, 10⁴, from low to high, until we find a value u, which satisfies the inequality

$$d {f}_{min} > {Σ}_{i = 1}^{2 k + 6} \frac{{d}_{i}^{2}}{{d}_{i}^{2} + u} .$$

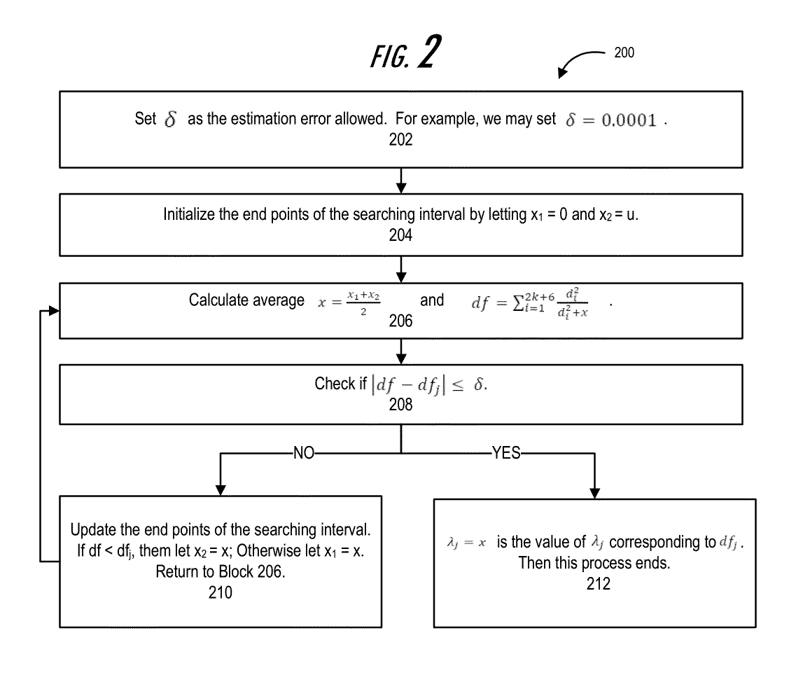

For each dfⱼ, we use the binary search algorithm described in FIG. 2 to search the λⱼ in the interval [0, u], so that the following equation is approximately met:

$$d {f}_{j} = {Σ}_{i = 1}^{2 k + 6} \frac{{d}_{i}^{2}}{{d}_{i}^{2} + {λ}_{j}} .$$

In practice, we may possibly select r=10×(2k+6), and

$$d {f}_{j} = \frac{j ( 2 k + 6 )}{r} = 0.1 j ( j = 1 , 2 , … , r ) .$$

FIG. 2 illustrates the binary search algorithm to determine λⱼ within an interval [0, u] for a given degrees of freedom dfⱼ. As illustrated by block 202 in FIG. 2, we first let δ be the estimation error allowed. For example, we may set 6=0.0001.

Block 204 illustrates that, the end points of the searching interval are defined by letting x₁=0, and x₂=u.

Block 206 of FIG. 2 illustrates that we calculate

$$x = \frac{{x}_{1} + {x}_{2}}{2} and d f = {Σ}_{i = 1}^{2 k + 6} \frac{{d}_{i}^{2}}{{d}_{i}^{2} + x} .$$

As illustrated by block 208, if |df−df|≦δ, then we proceed to Block 212 Otherwise, we proceed to block 210.

In block 210, the end points of the searching interval are updated. If df<dfⱼ, then let x₂=x, otherwise let x₁=x. We return to block 206 to recalculate

$$x = \frac{{x}_{1} + {x}_{2}}{2} and d f = {Σ}_{i = 1}^{2 k + 6} \frac{{d}_{i}^{2}}{{d}_{i}^{2} + x} .$$

The process is iterated until |df−df|≦δ is satisfied.

In block 212, we set λⱼ=x as the value of A corresponding to dfⱼ. Then we stop the binary search algorithm described in FIG. 2.

Returning to FIG. 1B, As illustrated by block 120, for each λⱼ, we calculate the parameter vector related to ridge regression:

$${\hat{β}}_{ridge} ( {λ}_{j} ) = {Q}_{2} Diag ( \frac{{d}_{1}}{{d}_{1}^{2} + {λ}_{j}} , \frac{{d}_{2}}{{d}_{2}^{2} + {λ}_{j}} , … , \frac{{d}_{2 k + 6}}{{d}_{2 k + 6}^{2} + {λ}_{j}} ) {Q}_{1}^{T} {z}^{*}$$

Block 122 illustrates that the validation data is used to apply test group model P₁ and control group model P₂ to score all records in the validation data. Then the equations in block 110 are applied to create U₁ (j=1, 2, . . . , k+3), and Vⱼ (j=1, 2, . . . , k+3) on the validation data. Using the same variable standardization formulas created in block 112, the variables Uⱼ (j=1, 2, . . . , k+3), and Vⱼ (j=1, 2, . . . , k+3) are standardized on the validation data to create Uⱼ (j=1, 2, . . . , k+3), and Vⱼ* (j=1, 2, , k+3).

As illustrated by block 124, using the validation data for each λⱼ, we create the corresponding score using the following formula for all observations.

S(λⱼ)=(U₁*, U₂*, . . . , Uₖ₊₃, V₁*, V₂*, . . . , Vₖ₊₃*)\hat{β}_{ridge}(λⱼ).

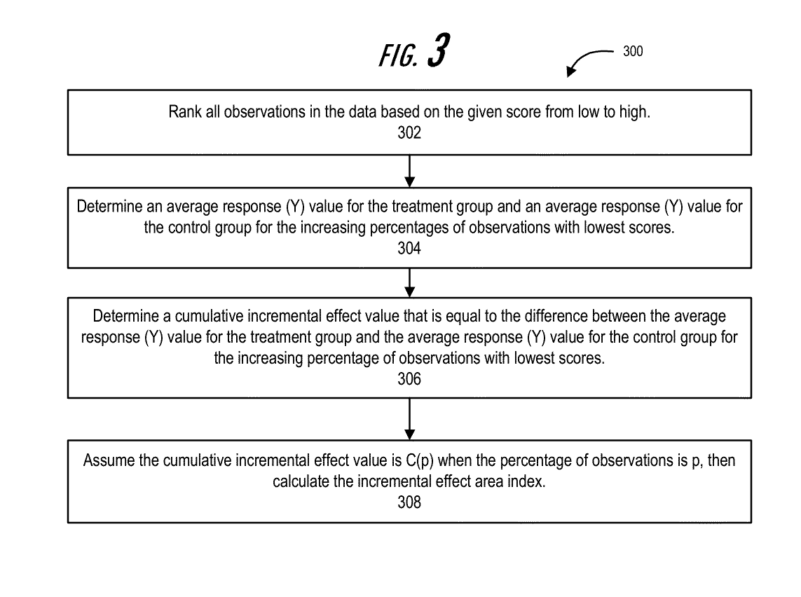

Block 126 illustrates that using validation data for each λⱼ, we calculate the incremental effect area index of the score S(λⱼ) using the process described in FIG. 3.

FIG. 3 illustrates a process for calculating the incremental effect area index for a given score. As illustrated by block 302, all observations in the data based on the given score are ranked from low to high.

Block 304 of FIG. 3 illustrates that we determine an average response (Y) value for the test group (e.g., with treatment) and an average response (Y) value for the control group (e.g., without treatment) for the increasing percentages of observations with lowest scores (e.g., at p₁=10%, p₂=20%, . . . , pₛ=100%, with s=10 points in total).

As illustrated by block 306, we determine a cumulative incremental effect value that is equal to the difference between the average response (Y) value for the treatment group and the average response (Y) value for the control group for the increasing percentages of observations with lowest scores (e.g., at p₁=10%, p₂=20%, . . . , pₛ=100%, with s=10 points in total).

Finally, as illustrated by block 308 of FIG. 3, we assume the cumulative incremental effect value is C(p) when the percentage of observations is p, and then calculate the incremental effect area index using the following formula:

$$1 - \frac{1}{C ( 1 )} \{ \frac{{p}_{1} + {p}_{2}}{2} C ( {p}_{1} ) + {\sum }_{i = 2}^{s} \frac{{p}_{i + 1} - {p}_{i - 1}}{2} C ( {p}_{i} ) + \frac{{p}_{s} - {p}_{s - 1}}{2} C ( {p}_{s} ) \}$$

Returning to FIG. 1B, as illustrated in block 128 from all the λⱼ's, we find the value that yields the highest incremental effect area index. For example, if the λⱼ with the highest incremental effect area index is λⱼ₀, then our final score is S(λⱼ₀), using the following scoring formula:

S(λⱼ₀)=(U₁*, U₂*, . . . , Uₖ₊₃, V₁*, V₂*, . . . , Vₖ₊₃*)\hat{β}_{ridge}(λⱼ₀).

The processes discussed in FIGS. 1A-3, will now be discussed with respect to an example model for receiving account payments. In the illustrated example a model is created to determine the incremental payment probability using test and control data, which was collected from a randomized experiment over several months. In each month, customers were randomly assigned to the test group for receiving the standard treatment for notification of payments, while the control group did not receive the additional notification (e.g., a telephone call, or other like notification). The goal of the process was to develop a score that ranks the net notification (e.g., a telephone call) treatment effect at an individual account level.

In total, the data contained 1,513,745 observations, with 1,457,771 observations in the test group and 55,974 observations in the control group. The number of observations in the test group and control group may be based on business decisions as long as both groups have a statistically significant amount of observations. As such, a business may not want to have as many observations in the control group as the test group because the business knows that there is an improvement in providing the treatment and the business may not want to lose out on potential opportunities with people in the control group that were not offered the treatment. As such, the split in the observations do not matter as long as there is enough data to be statistically significant. The opposite is also true for different types of purposes, for example an organization may not want as many observations in the test group as there are in the control group. We randomly split the whole data into three parts of approximately equal sizes: development data (485,924 observations), validation data (485,924 observations), and holdout data (485,923 observations). We will use the development data to find a set of candidate scores, and use the validation data to select the final score. In this example, the holdout data is set aside, purely for the purpose of evaluating the performance of the final score (e.g., to check if our methodology really works).

Among the 485,924 observations in the development data, 467,266 observations are in test group, and 18,658 are in control group We will use the 467,266 observations in test group of the development data to develop a logistic regression model P₁, to estimate the payment probability given the situation when the individual receives the notification treatment. Also, we will use the 18,658 observations in control group of the development data to develop a logistic regression model P₂, to estimate the payment probability given the situation when the individual does not receive notification treatment.

The quality of the test group payment probability model P₁ developed using the test group observations in the development data is determined by a validation on the test group observations in the holdout data. This data may be split into ten different deciles (or another number of groups) and the actual payment rate for each decile using the holdout data is compared to the predicted payment rate for the holdout data based on probability model P₁, as illustrated in Table 1. The quality of the score in rank ordering the decile level payment rates is measured by the KS statistic (Kolmogorov-Smirnov statistic). The KS statistics of the model described with respect to Table 1 is 0.379. Moreover, the differences between the actual pay rates and the predicted pay rates in Table 1 are close. As such based on the K-S statistic and Table 1, the model illustrates a good correlation. In other embodiments of the invention, other relative indicators may be utilized.

TABLE 1
Test Group Payment Probability
Model Validated on Test Group of Holdout
Data.

| | | Actual | |
|---|---|---|---|
| | Num. | Pay | Predicted |
| Decile | Observations | Rate | Pay Rate |
| 1 | 46726 | 96.93% | 97.10% |
| 2 | 46727 | 93.86% | 93.50% |
| 3 | 46726 | 90.54% | 89.84% |
| 4 | 46727 | 86.72% | 86.17% |
| 5 | 46726 | 82.67% | 82.44% |
| 6 | 46727 | 78.69% | 78.40% |
| 7 | 46727 | 73.28% | 73.75% |
| 8 | 46726 | 66.58% | 67.92% |
| 9 | 46727 | 58.09% | 59.65% |
| 10 | 46726 | 43.28% | 42.69% |

Similarly, the quality of the control group payment probability model P₂ is determined by a validation on the control group observations in the holdout data, as illustrated in Table 2. The KS statistics of the model described with respect to Table 2 is 0.353.

TABLE 2
Control Group Payment Probability
Model Validated on Control Group of
Holdout Data

| | | Actual | |
|---|---|---|---|
| | Num. | Pay | Predicted |
| Decile | Observations | Rate | Pay Rate |
| 1 | 1865 | 94.75% | 94.92% |
| 2 | 1866 | 91.96% | 90.87% |
| 3 | 1866 | 87.73% | 86.96% |
| 4 | 1866 | 81.73% | 82.91% |
| 5 | 1866 | 77.17% | 78.79% |
| 6 | 1866 | 72.94% | 74.32% |
| 7 | 1866 | 65.97% | 69.23% |
| 8 | 1866 | 60.40% | 63.16% |
| 9 | 1866 | 52.47% | 54.71% |
| 10 | 1865 | 41.93% | 39.47% |

Next, we examine the quality of the score utilizing the Differencing Score Method (DSM) in rank ordering the incremental payment rate. First we apply test group model P₁ to score all observations in the data, including observations both in test group and in control group, and apply the control group model P₂ to score all observations in the data. We then calculate the score P₁-P₂ for all observations. Next, all the scores of the observations in the data are ranked from low to high, and are then divided into ten deciles. The validation of the performance of the DSM score on hold out data is shown below in Table 3.

TABLE 3
Validation of the DSM Based Score on Holdout Data

| | | Num. | | Pay | |
|---|---|---|---|---|---|
| | Num. Obs. | Obs In | Pay Rate | Rate in | Incremental |
| Decile | In Test | Control | in Test | Control | Pay Rate |
| 1 | 46697 | 1895 | 58.97% | 55.20% | 3.77% |
| 2 | 46777 | 1815 | 73.05% | 68.98% | 4.07% |
| 3 | 46715 | 1878 | 80.15% | 76.84% | 3.31% |
| 4 | 46777 | 1815 | 84.24% | 80.33% | 3.91% |
| 5 | 46760 | 1833 | 84.62% | 82.21% | 2.41% |
| 6 | 46665 | 1927 | 83.90% | 79.35% | 4.56% |
| 7 | 46742 | 1850 | 80.97% | 75.95% | 5.02% |
| 8 | 46732 | 1861 | 78.15% | 72.43% | 5.72% |
| 9 | 46698 | 1894 | 75.16% | 69.91% | 5.25% |
| 10 | 46702 | 1890 | 71.41% | 66.30% | 5.12% |

As illustrated in Table 3, column two shows the number of observations in the test group for each decile, while column three shows the number of observations in the control group for each decile. Column four illustrates the payment rate of the observations in the test group for each decile in the form of a percentage. Alternatively, column five illustrates the payment rate of the observations in the control group for each decile in the form of a percentage. Finally, column six illustrates the difference between column four and column five (e.g., Pay rate in Test—Pay rate in Control equals to the incremental pay rate for each decile). The incremental pay rate in column six illustrates the net benefit of providing a notification (e.g., calling) versus not providing a notification (e.g., not calling) as it affects the payments received from customers. As can be seen, the bottom three deciles (e.g., 8, 9, and 10) all have an incremental pay rate less than 6%, while the top two deciles (e.g., 1 and 2) have an incremental pay rate of 3.77% and 4.07%. The DSM model rank orders the incremental pay rate fairly decently, such that the difference between the test group and the control group generally increases as the deciles increase. We would expect to see lower incremental pay rates in the lower deciles and higher incremental pay rates in the higher deciles. However, we note that the incremental pay rates determined using DSM are not very good because there is not a large difference between the first decile and the tenth decile. The incremental effect area index of the DSM score is 0.1443, which describes how good this score is.

Unlike the DSM process the Shadow Ridge Rescaling (SRR) method of the present invention may be utilized to achieve a better score than what was achieved using the DSM technique. The SRR method will be described herein with respect to the test group and control group utilized for the notification treatment for the customer payments.

Using the SRR method we first use the development data to determine a shadow dependent variable, Z. The development data has nₜ=467,266 observations in the test group, while there are n_{c}=18658 observations in the control group, and n=485924 observations in total. We set Y equal to the payment flag, which is equal to 1 when the individual makes a payment, and equal to 0 when the individual does not make a payment. As such, the shadow dependent variable is defined as follows:

$$Z = \{ \begin{matrix}\frac{485924}{467266} Y & if in test \\ - \frac{485924}{18658} Y & if in control\end{matrix}$$

The shadow dependent variable is defined for both the individuals in the test group and the individuals in the control group.

Next, we use development data to create cubic spline basis functions of the test group model P₁ and the control group model P₂ in order to predict the shadow dependent variable. In the illustrated example, nine (9) knots are created in the range of test model score P₁; and nine (9) knots are created in the range of control model score P₂. We then create the cubic spline basis functions Uⱼ (j=1, 2, . . . , 12) for test model score P₁, and the cubic spline basis functions Vⱼ(j=1, 2, . . . , 12) for control model score P₂. These cubic spline basis functions are created to capture the non-linear relationship between the shadow dependent variable and the test model score, and the nonlinear relationship between the shadow dependent variable and the control model score. Among the cubic spline basis functions of test model score P₁, the first variable U₁ is the test model score; the second variable U₂ is the square of the test model score; and the third variable U₃ is the cube of the test model score. The fourth to twelfth variables U₄, U₅, . . . , U₁₂ correspond to the nine knots, which are 10^{th} percentile, 20^{th} percentile, 30^{th} percentile, 40^{th} percentile . . . 90^{th} percentile of the test model score. As such, for the variable U₄, 10 percent of the test scores are less than or equal to 0.54035 for the variable U₅, 20 percent of the test scores are less than or equal to 0.64393, and so on. In this example, we use nine knots. In other embodiments, four knots, fourteen knots, or the like, may be used. However, the difference in the number of knots used should not make a large difference in the final results. The cubic spline functions are also created for the control model P₂ in a similar way. The cubic spline functions for the test group and the control group are illustrated below.

U₁=P₁;

U₂=P₁²;

U₃=P₁³;

U₄=(P₁−0.540358238)³*1(P₁>0.540358238);

U₅=(P₁−0.6439337129)³*1(P₁>0.6439337129);

U₆=(P₁−0.7108629511)³*1(P₁>0.7108629511);

U₇=(P₁−0.7622677387)³*1(P₁>0.7622677387);

U₈=(P₁−0.8053961368)³*1(P₁>0.8053961368);

U₉=(P₁−0.8437629734)³*1(P₁>0.8437629734);

U₁₀=(P₁−0.8804782645)³*1(P₁>0.8804782645);

U₁₁=(P₁−0.9169494037)³*1(P₁>0.9169494037);

U₁₂=(P₁−0.9534070854)³*1(P₁>0.9534070854);

V₁=P₂;

V₂=P₂²;

V₃=P₁³;

V₄=(P₂−0.4952273056)³*1(P₂>0.4952273056);

V₅=(P₂−0.5945287217)³*1(P₂>0.5945287217);

V₆=(P₂−0.6648411709)³*1(P₂>0.6648411709);

V₇=(P₂−0.7200278016)³*1(P₂>0.7200278016);

V₈=(P₂−0.7670823096)³*1(P₂>0.7670823096);

V₉=(P₂−0.8098625509)³*1(P₂>0.8098625509);

V₁₀=(P₂−0.8501250034)³*1(P₂>0.8501250034);

V₁₁=(P₂−0.8898952437)³*1(P₂>0.8898952437);

V₁₂=(P₂−0.9295838824)³*1(P₂>0.9295838824);

After the cubic spline functions are created we standardize the shadow dependent variable Z and all the above cubic spline basis functions by subtracting the variable's mean and dividing the difference by the variable's standard deviation, calculated from the development data. The standardization formulas are as follows:

$${Z}^{*} = \frac{Z - 0.033451275}{4.4750847335} ;$$

$${U}_{1}^{*} = \frac{{U}_{1} - 0.7716915504}{0.1623642497} ;$$

$${U}_{2}^{*} = \frac{{U}_{2} - 0.6218699443}{0.2274678367} ;$$

$${U}_{3}^{*} = \frac{{U}_{3} - 0.5164014925}{0.2551433301} ;$$

$${U}_{4}^{*} = \frac{{U}_{4} - 0.0270078761}{0.0266392368} ;$$

$${U}_{5}^{*} = \frac{{U}_{5} - 0.0096834438}{0.0117111104} ;$$

$${U}_{6}^{*} = \frac{{U}_{6} - 0.004128864}{0.0058470883} ;$$

$${U}_{7}^{*} = \frac{{U}_{7} - 0.0018323275}{0.0029891638} ;$$

$${U}_{8}^{*} = \frac{{U}_{8} - 0.0007903345}{0.0014804078} ;$$

$${U}_{9}^{*} = \frac{{U}_{9} - 0.000310331}{0.000672439} ;$$

$${U}_{10}^{*} = \frac{{U}_{10} - 0.0000970969}{0.01002502499} ;$$

$${U}_{11}^{*} = \frac{{U}_{11} - 0.0000189929}{0.0000622992} ;$$

$${U}_{12}^{*} = \frac{{U}_{12} - 1.1875784 E - 6}{6.0844262 E - 6} ;$$

$${V}_{1}^{*} = \frac{{V}_{1}^{*} - 0.7362592367}{0.1667051425} ;$$

$${V}_{2}^{*} = \frac{{V}_{2}^{*} - 0.569868211}{0.2260103598} ;$$

$${V}_{3}^{*} = \frac{{V}_{3}^{*} - 0.4568093121}{0.24570949014} ;$$

$${V}_{4}^{*} = \frac{{V}_{4}^{*} - 0.0307920524}{0.031320112} ;$$

$${V}_{5}^{*} = \frac{{V}_{5}^{*} - 0.0122639683}{0.014982602} ;$$

$${V}_{6}^{*} = \frac{{V}_{6}^{*} - 0.0053919063}{0.0076751747} ;$$

$${V}_{7}^{*} = \frac{{V}_{7}^{*} - 0.0024348735}{0.0039862985} ;$$

$${V}_{8}^{*} = \frac{{V}_{8}^{*} - 0.0010580758}{0.0019923352} ;$$

$${V}_{9}^{*} = \frac{{V}_{9}^{*} - 0.0004104918}{0.0009007788} ;$$

$${V}_{10}^{*} = \frac{{V}_{10}^{*} - 0.0001291573}{0.0003405421} ;$$

$${V}_{11}^{*} = \frac{{V}_{11}^{*} - 0.0000261082}{0.0000894997} ;$$

$${V}_{12}^{*} = \frac{{V}_{12}^{*} - 1.9252877 E - 6}{0.0000109624} ;$$

Next, we apply ridge regression to best predict Z* based on the linear combination of the standardized cubic spline basis Uⱼ*'s and Vⱼ*'s :

α₁U₁*+α₂U₂*+ . . . +α₁₂U₁₂*+γ₁V₁*+γ₂V₂*+ . . . +γ₁₂V₁₂*.

To find the coefficients that best predict Z* we create the design matrix X, with its column vectors corresponding to the variables Uⱼ*'s and Sⱼ*'s (e.g., 24 variables in total). Then the coefficient vector β=(α₁, α₂, . . . , α₁₂, γ₂, . . . , γ₁₂)^{T} can be determined by the following equation:

\hat{β}_{ridge}(λ)=(X^{T}X+λI)⁻¹X^{T}z*,

with z* equal to the vector corresponding to the standardized shadow dependent variable Z*. In other embodiments, as previously discussed an alternative and more efficient way of calculating \hat{β}^{ridge}(λ) is based on singular value decomposition (SVD), described with respect to blocks 116 and 118 in FIG. 1B, using equations (8) and (9) described above.

We still need to determine the tuning parameter λ, to achieve the best score at the end of the process. In the present example we test 240 candidate values of λ, with corresponding degrees of freedom 0.1, 0.2, . . . , 23.9, 24.0, respectively. For each value of λ, we calculate the coefficient vector \hat{β}^{ridge}(λ) =(\hat{α}₁(λ), \hat{α}₂(λ), . . . , \hat{α}₁₂(λ), \hat{γ}₁(λ), \hat{γ}₂(λ), . . . , \hat{γ}₁₂(λ))^{T} using either equation \hat{β}^{ridge} (λ)=(X^{T}X+λI)⁻¹X^{T}z*, or the SVD (e.g., equations (8) and (9)). Then we create the scoring equation as

S(λ)=\hat{α}₁(λ)U₁*+ . . . +\hat{α}₁₂(λ)U₁₂*+\hat{γ}₁(λ)V₁*+ . . . +\hat{γ}₁₂(λ)V₁₂*.

Next, we will finalize the choice of λ based on the available validation data set. For a given λ, we apply the scoring formulas obtained from the development data, including the formulas for creating cubic spline basis functions, the formulas for standardization, and the scoring equation to the validation data, to create a score. Then we calculate the incremental effect area index based on the score using the validation data, to measure the quality of the score. We do this for each of the 240 values of λ. The λ value corresponding to the score with the maximum incremental effect area index is our optimal λ, and thus becomes our final choice.

In this example, the optimal λ is 302,270, with a corresponding degrees of freedom of 4.0. Our final scoring formula is:

$$S = 0.000465833 \times {U}_{1}^{*} + 0.000494389 \times {U}_{2}^{*} + 0.0004613788 \times {U}_{3}^{*} + 0.0001782148 \times {U}_{4}^{*} + - 0.000075888 \times {U}_{5}^{*} + - 0.000264481 \times {U}_{6}^{*} + - 0.000352704 \times {U}_{7}^{*} + - 0.000360696 \times {U}_{8}^{*} + - 0.000265191 \times {U}_{9}^{*} + - 0.00011825 \times {U}_{10}^{*} + 0.0001197716 \times {U}_{11}^{*} + 0.0004126004 \times {U}_{12}^{*} + - 0.0009875 \times {V}_{1}^{*} + - 0.000831548 \times {V}_{2}^{*} + - 0.00073795 \times {V}_{3}^{*} + - 0.000514143 \times {V}_{4}^{*} + - 0.000490688 \times {V}_{5}^{*} + - 0.000534897 \times {V}_{6}^{*} + - 0.000684971 \times {V}_{7}^{*} + - 0.000857281 \times {V}_{8}^{*} + - 0.000908754 \times {V}_{9}^{*} + - 0.00081011 \times {V}_{10}^{*} + - 0.000769221 \times {V}_{11}^{*} + - 0.000206515 \times {V}_{12}^{*} .$$

Finally, we validate our score using the holdout data. All the observations in the holdout data are ranked from low to high, and are then divided into 10 deciles. The performance of the SRR based score is validated on the holdout data, and is shown below in Table 4.

TABLE 4
Validation of SRR Based Score on the Holdout Data

| | | Num. | | Pay | |
|---|---|---|---|---|---|
| | Num. Obs. | Obs In | Pay Rate | Rate in | Incremental |
| Decile | In Test | Control | in Test | Control | Pay Rate |
| 1 | 46761 | 1831 | 96.52% | 94.81% | 1.71% |
| 2 | 46698 | 1894 | 93.43% | 92.24% | 1.20% |
| 3 | 46682 | 1911 | 89.71% | 87.39% | 2.32% |
| 4 | 46809 | 1783 | 84.69% | 80.76% | 3.93% |
| 5 | 46717 | 1876 | 78.78% | 74.09% | 4.68% |
| 6 | 46731 | 1861 | 73.73% | 68.62% | 5.12% |
| 7 | 46720 | 1872 | 68.57% | 64.10% | 4.47% |
| 8 | 46759 | 1834 | 64.98% | 58.67% | 6.31% |
| 9 | 46669 | 1923 | 60.76% | 53.93% | 6.83% |
| 10 | 46719 | 1873 | 59.43% | 52.96% | 6.47% |

This new score has an incremental effect area index 0.3944, as calculated by the incremental effect area index described generally herein, and in further detail in U.S. Patent Applicant No. 2013/0238539, which was previously incorporated by referenced herein. As a comparison, the score based on differencing score method (DSM) has a much lower area index 0.1443. For this new score, all the bottom three deciles have an incremental pay rate greater than 6%; and the top two deciles have an incremental pay rate less than 2%. Obviously, the new score, which is based on shadow ridge rescaling, is much stronger than the DSM based score in terms of rank ordering the incremental pay rate.

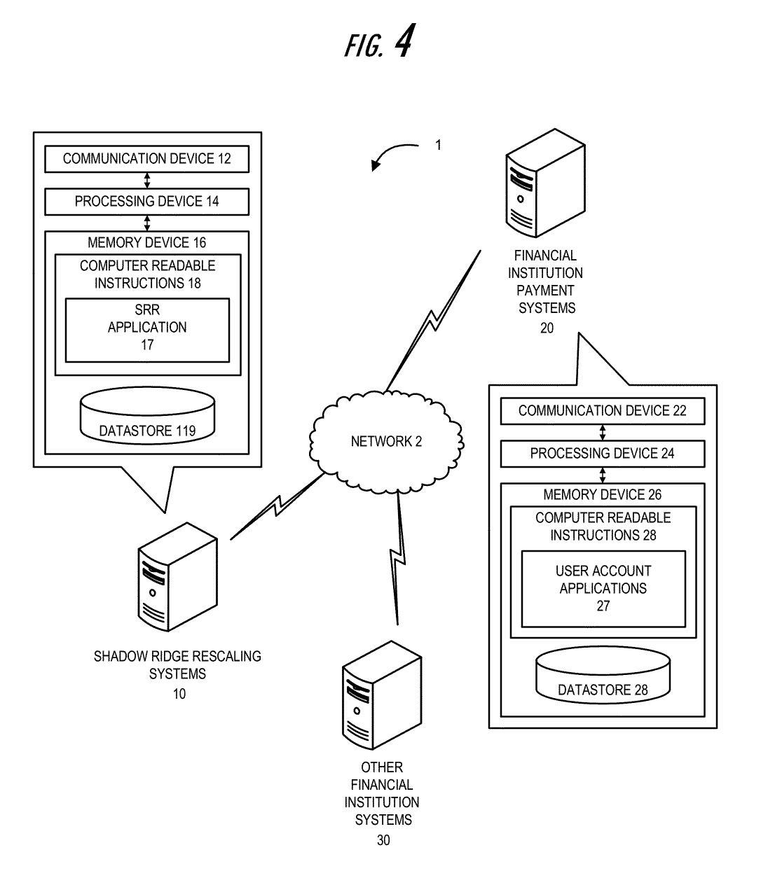

FIG. 4 presents a block diagram of the modeling system 1 environment for implementing the process flows described in FIGS. 1A-3 in accordance with embodiments of the present invention. As illustrated in FIG. 4, the shadow ridge rescaling (SRR) systems 10 are operatively coupled, via a network 2 to the financial institution payment systems 20, other financial institution systems 30, or the like. In this way, the SRR systems 10 may utilize the payment information from the financial institution systems 20 or other information from other financial institution systems 30 when determining the incremental effect of a treatment used within the financial institution. FIG. 4 illustrates only one example of embodiments of the modeling system 1 environment, and it will be appreciated that in other embodiments one or more of the systems (e.g., computers, mobile devices, servers, or other like systems) may be combined into a single system or be made up of multiple systems.

The network 2 may be a global area network (GAN), such as the Internet, a wide area network (WAN), a local area network (LAN), or any other type of network or combination of networks. The network 2 may provide for wireline, wireless, or a combination of wireline and wireless communication between devices on the network.

As illustrated in FIG. 4, the user SRR systems computer systems 10 generally comprise a communication device 12, a processing device 14, and a memory device 16. As used herein, the term “processing device” generally includes circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 14 is operatively coupled to the communication device 12 and the memory device 16. The processing device 14 uses the communication device 12 to communicate with the network 2 and other devices on the network 2, such as, but not limited to, the financial institution payment systems 20, or other financial institution systems 30. As such, the communication device 12 generally comprises a modem, server, or other device for communicating with other devices on the network 2, and a display, camera, keypad, mouse, keyboard, microphone, and/or speakers for communicating with one or more users 2.

As further illustrated in FIG. 4, the SRR systems 10 comprises computer-readable instructions 18 stored in the memory device 16, which in one embodiment includes the computer-readable instructions 18 of a SRR application 17 (e.g., application that models treatments based on test and control groups). In some embodiments, the memory device 16 includes a datastore 19 for storing data related to the SRR systems 10, including but not limited to data created and/or used by the SRR application 17. As discussed above, the SRR application 17 allows for the implementation of the SRR modeling technique for analyzing treatments associated with customers of the financial institution, either related specifically to payments, or generally to any product (e.g., good or service) within the financial institution as well as any internal process within the financial institution.

As further illustrated in FIG. 4, the financial institution payment systems 20 generally comprise a communication device 22, a processing device 24, and a memory device 26. The processing device 24 is operatively coupled to the communication device 22 and the memory device 26. The processing device 24 uses the communication device 22 to communicate with the network 2, and other devices on the network 2, such as, but not limited to, the SRR systems 10, and/or the other financial institution systems 30. As such, the communication device 22 generally comprises a modem, server, or other device(s) for communicating with other devices on the network 2.

As illustrated in FIG. 4, the financial institution payment systems 20 comprise computer-readable program instructions 28 stored in the memory device 26, which in one embodiment includes the computer-readable instructions 28 of payment applications 27. In some embodiments, the memory device 26 includes a datastore 29 for storing data related to the financial institution payment systems 20, including but not limited to data created and/or used by the payment applications 27. The payment applications 27 process payments made by customers that can be used to provide data to the SRR application 17 that can determine the incremental effect of treatments instituted with respect to payments, or other products within the financial institution.

As further illustrated in FIG. 4, the other financial institution systems 30 are operatively coupled to the SRR systems 10, and/or the financial institution payment systems 20 through the network 2. The other financial institution systems 30 have devices that are the same as or similar to the devices described for the SRR systems 10 and/or the financial institution payment systems 20 (e.g., communication device, processing device, memory device with computer-readable instructions, datastore, or the like). Thus, the other financial institution systems 30 communicate with the SRR systems 10 and/or the financial institution payment systems 20 in the same or similar way as previously described with respect to these systems above. The other financial institution systems 30, in some embodiments, provides additional data that can be utilized by the SRR systems 10 to utilize the SRR modeling technique to analyze the incremental effect of treatments on various products for customers or processes within the financial institution.

It is understood that the systems and devices described herein illustrate one embodiment of the invention. It is further understood that one or more of the systems, devices, or the like can be combined or separated in other embodiments and still function in the same or similar way as the embodiments described herein.

The invention described herein is illustrated as being utilized within financial institution systems using applications from within the financial institution; however, it should be understood that the SRR modeling technique may be utilized when comparing any test and control group data. For example, it may be utilized in the pharmaceutical industry, software industry, or any other type of industry. As such, the systems and applications described herein may not be financial institution systems and applications and instead may be systems and applications that are utilized in other industries.

Moreover, any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Pearl, Smalltalk, C++ or the like. However, the computer program code/computer-readable instructions for carrying out operations of the invention may also be written in conventional procedural programming languages, such as the “C” programming language or similar programming languages.

Embodiments of the present invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for modeling incremental effect, the system comprising:
a memory device; and
a processing device operatively coupled to the memory device, wherein the processing device is configured to execute computer-readable program code to:
split data for observations into development data and validation data;
create a test group model from the development data based on test group observations that are subject to a treatment;
create a control group model from the development data based on control group observations that are not subject to the treatment;
create a shadow dependent variable for the development data, wherein the shadow dependent variable is dependent on the test group observations, the control group observations, and a measurement performance variable;
score the development data by applying the test group model and the control group model to the development data;
create cubic spline basis functions for the test group model and the control group model;
standardize the shadow dependent variable and the cubic spline basis functions using the development data;
create a design matrix of the standardized shadow dependent variable and the cubic spline basis functions;
conduct a singular value decomposition on the design matrix;
utilize a binary search algorithm to determine tuning parameters for a set of degree of freedoms from the singular value decomposition;
calculate a parameter vector for each of the tuning parameters;
create a scoring formula based on the standardized cubic spline basis functions and the parameter vector for each of the tuning parameters;
calculate scores for each of the tuning parameters using the scoring formula and the validation data;
calculate an incremental effect area index of the scores for the tuning parameters values using the validation data;
identify a tuning parameter from the tuning parameters corresponding to a score from the scores that has a highest incremental effect area index; and
wherein the tuning parameter with the score having the highest incremental effect area index is used to rank order an incremental effect of the treatment.

2. The system of claim 1, wherein the observations are further split into holding data that is used to determine the accuracy of the incremental effect model score.

3. The system of claim 1, wherein the shadow dependent variable is defined by the following equation:
$$Z = \{ \begin{matrix}\frac{n}{{n}_{t}} Y & if the individual is in test \\ - \frac{n}{{n}_{c}} Y & if the individual is in control ;\end{matrix}$$
and
wherein nₜ is a number of test group observation, n_{c} is a number of control group observations, n is a total number of observations, and Y is the measurement performance variable.

4. The system of claim 1, wherein the cubic spline basis functions of the test group are
$${U}_{1} = {P}_{1} , \\ {U}_{2} = {P}_{1}^{2} , \\ {U}_{3} = {P}_{1}^{3} , \\ {U}_{4} = {( {P}_{1} - {a}_{1} )}^{3} \cdot 1 ( {P}_{1} \leq {a}_{1} ) , \\ {U}_{5} = {( {P}_{1} - {a}_{2} )}^{3} \cdot 1 ( {P}_{1} \leq {a}_{2} ) , \\ … … … …$$
$${U}_{k + 3} = {( {P}_{1} - {a}_{k} )}^{3} \cdot 1 ( {P}_{1} \leq {a}_{k} ) ;$$
the cubic spline basis functions of the control group are
$${V}_{1} = {P}_{2} , \\ {V}_{2} = {P}_{2}^{2} , \\ {V}_{3} = {P}_{2}^{3} , \\ {V}_{4} = {( {P}_{2} - {b}_{1} )}^{3} \cdot 1 ( {P}_{2} \leq {b}_{1} ) , \\ {V}_{5} = {( {P}_{2} - {b}_{2} )}^{3} \cdot 1 ( {P}_{2} \leq {b}_{2} ) , \\ … … … …$$
$${V}_{k + 3} = {( {P}_{2} - {b}_{k} )}^{3} \cdot 1 ( {P}_{2} \leq {b}_{k} ) .$$

5. The system of claim 1, wherein standardizing the shadow dependent variable and the cubic spline basis functions using the development data comprises subtracting the variable's mean and dividing the difference by the variable's standard deviation, wherein the mean the standard deviation are calculated from the development data.

6. The system of claim 1, wherein conducting the value decomposition for the design matrix (X) comprises using a formula
X=Q₁DQ₂^{T}; and
wherein Q₁ and Q₂ are n×(2k+6) and (2k+6)×(2k+6) orthogonal matrices, D is a (2k+6)×(2k+6) diagonal matrix, with diagonal entries d₁≧d₂≧ . . . ≧d₂ₖ₊₆≧0 called the singular values of matrix X.

7. The system of claim 1, wherein utilizing the binary search algorithm to determine the tuning parameters for the set of degree of freedoms from the singular value decomposition comprises:
set δ as an estimation error allowed;
identify the tuning parameters for each dfⱼ;
initialize end points of the searching interval by letting x₁=0 and x₂=u;
calculate
$$x = \frac{{x}_{1} + {x}_{2}}{2}$$
$$and$$
$$df = {\sum }_{i = 1}^{2 k + 6} \frac{{d}_{i}^{2}}{{d}_{i}^{2} + x} ;$$
when |df−dfⱼ|≦δ then x is the value of the turning parameter corresponding to dfⱼ;
when |df−dfⱼ|>δ then update the end points such that if df<dfⱼ then let x₂=x, otherwise let x₁=x, recalculate
$$x = \frac{{x}_{1} + {x}_{2}}{2}$$
$$and$$
$$df = {\sum }_{i = 1}^{2 k + 6} \frac{{d}_{i}^{2}}{{d}_{i}^{2} + x} ,$$
and iterate until |df−drⱼ|≦δ is met.

8. The system of claim 1, wherein the parameter vector is calculated for each of the tuning parameters λⱼ using the following formula:
$${\hat{β}}_{ridge} ( {λ}_{j} ) = {Q}_{2} Diag ( \frac{{d}_{1}}{{d}_{1}^{2} + {λ}_{j}} , \frac{{d}_{2}}{{d}_{2}^{2} + {λ}_{j}} , … , \frac{{d}_{2 k + 6}}{{d}_{2 k + 6}^{2} + {λ}_{j}} ) {Q}_{1}^{T} {z}^{*} .$$

9. The system of claim 1, wherein the scoring formula is
S(λⱼ)=(U₁*, U₂*, . . . , Uₖ₊₃*, V₁*, V₂*, . . . , Vₖ₊₃*)\hat{β}_{ridge}(λⱼ).

10. The system of claim 1, wherein calculating the incremental effect area index of the scores for the tuning parameters values using the validation data comprises:
ranking the observations in the validation data based on the scores from low to high;
determining an average response (Y) value for the test group and the an average response variable (Y) value for the control group for increasing percentages of observations of the scores from lowest to highest;
determining a cumulative incremental effect value that is equal to the difference between the average response (Y) value for the test group and the average response (Y) value for the control group for the increasing percentages of observations of the scores from lowest to highest;
assuming the cumulative incremental effect value is C(p) when the percentage of observations is p; and
calculating the incremental effect area index using formula:
$$1 - \frac{1}{C ( 1 )} \{ \frac{{p}_{1} + {p}_{2}}{2} C ( {p}_{1} ) + {\sum }_{i = 2}^{s} \frac{{p}_{i + 1} - {p}_{i - 1}}{2} C ( {p}_{i} ) + \frac{{p}_{s} - {p}_{s - 1}}{2} C ( {p}_{s} ) \} .$$

11. A computer program product for modeling incremental effect, the computer program product comprising at least one non-transitory computer-readable medium having computer-readable program code portions embodied therein, the computer-readable program code portions comprising:
an executable portion configured to split data for observations into development data and validation data;
an executable portion configured to create a test group model from the development data based on test group observations that are subject to a treatment;
an executable portion configured to create a control group model from the development data based on test group observations that fail to be subject to the treatment;
an executable portion configured to create a shadow dependent variable for the development data, wherein the shadow dependent variable is dependent on the test group observations, the control group observations, and a measurement performance variable;
an executable portion configured to score the development data by applying the test group model and the control group model to the development data;
an executable portion configured to create cubic spline basis functions for the test group model and the control group model;
an executable portion configured to standardize the shadow dependent variable and the cubic spline basis functions using the development data;
an executable portion configured to create a design matrix of the standardized shadow dependent variable and the cubic spline basis functions;
an executable portion configured to conduct a singular value decomposition on the design matrix;
an executable portion configured to utilize a binary search algorithm to determine tuning parameters for a set of degree of freedoms from the singular value decomposition;
an executable portion configured to calculate a parameter vector for each of the tuning parameters;
an executable portion configured to create a scoring formula based on the standardized cubic spline basis functions and the parameter vector for each of the tuning parameters;
an executable portion configured to calculate scores for each of the tuning parameters using the scoring formula and the validation data;
an executable portion configured to calculate an incremental effect area index of the scores for the tuning parameters values using the validation data;
an executable portion configured to identify a tuning parameter from the tuning parameters that has a highest incremental effect area index; and
wherein the tuning parameter with the score having the highest incremental effect area index is used to rank order an incremental effect of the treatment.

12. The computer program product of claim 11, wherein the observations are further split into holding data that is used to determine the accuracy of the incremental effect model score.

13. The computer program product of claim 11, wherein the shadow dependent variable is defined by the following equation:
$$Z = \{ \begin{matrix}\frac{n}{{n}_{t}} Y & if the individual is in test \\ - \frac{n}{{n}_{c}} Y & if the individual is in control ;\end{matrix}$$
and
wherein nₜ is a number of test group observation, n_{c} is a number of control group observations, n is a total number of observations, and Y is the measurement performance variable.

14. The computer program product of claim 11, wherein the cubic spline basis functions of the test group are
$${U}_{1} = {P}_{1} , \\ {U}_{2} = {P}_{1}^{2} , \\ {U}_{3} = {P}_{1}^{3} , \\ {U}_{4} = {( {P}_{1} - {a}_{1} )}^{3} \cdot 1 ( {P}_{1} \leq {a}_{1} ) , \\ {U}_{5} = {( {P}_{1} - {a}_{2} )}^{3} \cdot 1 ( {P}_{1} \leq {a}_{2} ) , \\ … … … …$$
$${U}_{k + 3} = {( {P}_{1} - {a}_{k} )}^{3} \cdot 1 ( {P}_{1} \leq {a}_{k} ) ;$$
the cubic spline basis functions of the control group are
$${V}_{1} = {P}_{2} , \\ {V}_{2} = {P}_{2}^{2} , \\ {V}_{3} = {P}_{2}^{3} , \\ {V}_{4} = {( {P}_{2} - {b}_{1} )}^{3} \cdot 1 ( {P}_{2} \leq {b}_{1} ) , \\ {V}_{5} = {( {P}_{2} - {b}_{2} )}^{3} \cdot 1 ( {P}_{2} \leq {b}_{2} ) , \\ … … … …$$
$${V}_{k + 3} = {( {P}_{2} - {b}_{k} )}^{3} \cdot 1 ( {P}_{2} \leq {b}_{k} ) .$$

15. The computer program product of claim 11, wherein standardizing the shadow dependent variable and the cubic spline basis functions using the development data comprises subtracting the variable's mean and dividing the difference by the variable's standard deviation, wherein the mean the standard deviation are calculated from the development data.

16. The computer program product of claim 11, wherein conducting the value decomposition for the design matrix (X) comprises using a formula
X=Q₁DQ₂^{T}; and
wherein Q₁ and Q₂ are n×(2k+6) and (2k+6)×(2k+6) orthogonal matrices, D is a (2k+6)×(2k+6) diagonal matrix, with diagonal entries d₁≧d₂≧ . . . ≧d₂ₖ₊₆≧0 called the singular values of matrix X.

17. The computer program product of claim 11, wherein utilizing the binary search algorithm to determine the tuning parameters for the set of degree of freedoms from the singular value decomposition comprises:
set δ as an estimation error allowed;
identify the tuning parameters for each dfⱼ;
initialize end points of the searching interval by letting x₁=0 and x₂=u;
calculate
$$x = \frac{{x}_{1} + {x}_{2}}{2}$$
$$and$$
$$df = {\sum }_{i = 1}^{2 k + 6} \frac{{d}_{i}^{2}}{{d}_{i}^{2} + x} ;$$
when |df−df|≦δ then×is the value of the turning parameter corresponding to dfⱼ;
when |df−df|>δ then update the end points such that if df<dfⱼ then let x₂=x, otherwise let x₁=x, recalculate
$$x = \frac{{x}_{1} + {x}_{2}}{2}$$
$$and$$
$$df = {\sum }_{i = 1}^{2 k + 6} \frac{{d}_{i}^{2}}{{d}_{i}^{2} + x} ,$$
and iterate until |df−dfⱼ|δ is met.

18. The computer program product of claim 11, wherein the parameter vector is calculated for each of the tuning parameters λⱼ using the following formula:
$${\hat{β}}_{ridge} ( {λ}_{j} ) = {Q}_{2} Diag ( \frac{{d}_{1}}{{d}_{1}^{2} + {λ}_{j}} , \frac{{d}_{2}}{{d}_{2}^{2} + {λ}_{j}} , … , \frac{{d}_{2 k + 6}}{{d}_{2 k + 6}^{2} + {λ}_{j}} ) {Q}_{1}^{T} {z}^{*} .$$

19. The computer program product of claim 11, wherein the scoring formula is
S(λⱼ)=(U₁*, U₂*, . . . , V₁*, V₂*, . . . , Vₖ₊₃*)\hat{β}_{ridge}(λⱼ).

20. The computer program product of claim 11, wherein calculating the incremental effect area index of the scores for the tuning parameters values using the validation data comprises:
ranking the observations in the validation data based on the scores from low to high;
determining an average response (Y) value for the test group and the an average response variable (Y) value for the control group for increasing percentages of observations of the scores from lowest to highest;
determining a cumulative incremental effect value that is equal to the difference between the average response (Y) value for the test group and the average response (Y) value for the control group for the increasing percentages of observations of the scores from lowest to highest;
assuming the cumulative incremental effect value is C(p) when the percentage of observations is p; and
calculating the incremental effect area index using formula:
$$1 - \frac{1}{C ( 1 )} \{ \frac{{p}_{1} + {p}_{2}}{2} C ( {p}_{1} ) + {\sum }_{i = 2}^{s} \frac{{p}_{i + 1} - {p}_{i - 1}}{2} C ( {p}_{i} ) + \frac{{p}_{s} - {p}_{s - 1}}{2} C ( {p}_{s} ) \} .$$

21. A method for modeling incremental effect, the method comprising:
splitting, by a processor, data for observations into development data and validation data;
creating, by a processor, a test group model from the development data based on test group observations that are subject to a treatment;
creating, by a processor, a control group model from the development data based on test group observations that fail to be subject to the treatment;
creating, by a processor, a shadow dependent variable for the development data, wherein the shadow dependent variable is dependent on the test group observations, the control group observations, and a measurement performance variable;
scoring, by a processor, the development data by applying the test group model and the control group model to the development data;
creating, by a processor, cubic spline basis functions for the test group model and the control group model;
standardizing, by a processor, the shadow dependent variable and the cubic spline basis functions using the development data;
creating, by a processor, a design matrix of the standardized shadow dependent variable and the cubic spline basis functions;
conducting, by a processor, a singular value decomposition on the design matrix;
utilizing, by a processor, a binary search algorithm to determine tuning parameters for a set of degree of freedoms from the singular value decomposition;
calculating, by a processor, a parameter vector for each of the tuning parameters;
creating, by a processor, a scoring formula based on the standardized cubic spline basis functions and the parameter vector for each of the tuning parameters;
calculating, by a processor, scores for each of the tuning parameters using the scoring formula and the validation data;
calculating, by a processor, an incremental effect area index of the scores for the tuning parameters values using the validation data;
identifying, by a processor, a tuning parameter from the tuning parameters that has a highest incremental effect area index; and
wherein the tuning parameter with the score having the highest incremental effect area index is used to rank order an incremental effect of the treatment.
